(19) United States
(12) Patent Application Publication
(10) Pub. No.: US 2012/0052369 A1
(43) Pub. Date: Mar. 1, 2012

(54) ELECTRODE ASSEMBLY, SECONDARY BATTERY INCLUDING THE SAME, AND METHOD OF MANUFACTURING THE SAME

(76) Inventor: Hyoung-No Lee, Yongin-si (KR)

(21) Appl. No.: 13/196,822

(22) Filed: Aug. 2, 2011

(30) Foreign Application Priority Data
Aug. 25, 2010 (KR) 10-2010-0082404

(51) Int. Cl. H01M 2/16; H01M 10/04; H01M 4/139; H01M 2/02

(52) U.S. Cl. 429/163; 429/246; 29/623.1; 29/623.5

(57) ABSTRACT

An electrode assembly includes a positive plate, a negative plate, and a separator located between the positive plate and the negative plate, each of the positive plate and the negative plate having an active part formed by applying an active material to at least one surface and a non-applied part from which the active material is omitted, wherein a side part extending from at least one of the active part of the positive plate and the active part of the negative plate is coated with an inorganic coating layer.

### CROSS-REFERENCE TO RELATED APPLICATION

This application claims priority to and the benefit of Korean Patent Application No. 10-2010-0082404, filed on Aug. 25, 2010, in the Korean Intellectual Property Office, the entire content of which is incorporated herein by reference.

### BACKGROUND

1. Field

The embodiment relates to an electrode assembly and a secondary battery including the same.

2. Description of Related Art

A secondary battery is provided for use by winding an electrode assembly, accommodating the electrode assembly in a case, injecting an electrolyte into the case, and sealing the case, the electrode assembly being formed by applying an active material to each of a positive current collector and a negative current collector and inserting a separator therebetween.

The separator may be formed of polyethylene (PE) or polypropylene (PP)-based porous materials to prevent a short circuit by direct contact between a positive electrode and a negative electrode. However, when a short circuit occurs due to internal foreign substances or external impact, the porous structure of the separator may be fractured or melted due to a low thermal stability of the porous materials, potentially causing the separator to stop functioning properly.

Further, occurrence of a short circuit or explosion of a battery may be caused by burrs which are inevitably formed on cut surfaces of a positive plate and a negative plate, and thus solutions to safety issues are desirable.

### SUMMARY

An aspect of the present invention provides for an electrode assembly which relieves occurrence of burrs on a cut surface of the electrode assembly and supplements a low thermal stability of a separator.

According to an aspect of the present invention, an electrode assembly is provided including a positive plate, a negative plate, and a separator located between the positive plate and the negative plate, each of the positive plate and the negative plate having an active part formed by applying an active material to at least one surface and a non-applied part from which the active material is omitted, wherein a side part extending from at least one of the active part of the positive plate and the active part of the negative plate is coated with an inorganic coating layer.

In one embodiment, the inorganic coating layer covers the side part in a lengthwise direction of the positive plate or the negative plate and may entirely cover the active part. Additionally, the inorganic coating layer may cover a portion of the non-applied part.

In one embodiment, the inorganic coating layer comprises a dried inorganic ceramic material which may include ceramic powder of at least one selected from alumina, zirconia, and an alumina-zirconia mixture.

In another embodiment, a secondary battery is provided including an electrode assembly having a positive plate, a negative plate, and a separator located between the positive plate and the negative plate, each of the positive plate and the negative plate including an active part formed by applying an active material to at least one surface and a non-applied part from which the active material is omitted, wherein a side part extending from at least one of the active part of the positive plate and the active part of the negative plate is coated with an inorganic coating layer; a positive tab and a negative tab respectively connected to the positive plate and the negative plate of the electrode assembly; and a case housing the electrode assembly.

Further, in another embodiment, a method of manufacturing a secondary battery including an electrode assembly having a positive plate, a negative plate, and a separator located between the positive plate and the negative plate is provided, the method including applying an active material to a portion at least one surface of the positive plate and the negative plate to form an active part and a non-applied part to which the active material is omitted; cutting the positive plate or the negative plate into a desired size; and applying an inorganic coating layer on a side part extending from at least one of the active part of the positive plate and the active part of the negative part.

In embodiments, the cutting and the applying the inorganic coating layer are performed simultaneously or sequentially. Additionally, the inorganic coating layer may be applied to cover the side part in a lengthwise direction of the positive plate or the negative plate. Further, the inorganic coating layer may be applied to cover the entire active part and also to cover a portion of the non-applied part.

As described above, according to exemplary embodiments of the present invention, there is provided a secondary battery which relieves occurrence of burrs on a cut surface of the electrode assembly and supplements a low thermal stability of a separator and a method of manufacturing the same. Moreover, the likelihood of a short circuit and explosion of a battery is significantly reduced to improve reliability of a product. In addition, the likelihood of a defective battery being manufactured is minimized, thereby reducing manufacturing costs.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view illustrating an electrode assembly of a secondary battery according to an exemplary embodiment of the present invention;

FIG. 2A is a cross-sectional view schematically illustrating a positive plate of the secondary battery according to the exemplary embodiment of the present invention;

FIG. 2B is a perspective view schematically illustrating the positive plate of the secondary battery according to the exemplary embodiment of the present invention;

FIG. 3A is a cross-sectional view schematically illustrating a positive plate of a secondary battery according to another exemplary embodiment of the present invention;

FIG. 3B is a perspective view schematically illustrating the positive plate of the secondary battery according to the other exemplary embodiment of the present invention;

FIG. 4A is a cross-sectional view schematically illustrating a negative plate of a secondary battery according to an exemplary embodiment of the present invention;

FIG. 4B is a perspective view schematically illustrating the negative plate of FIG. 4A;

FIG. 5A is a cross-sectional view schematically illustrating a negative plate of a secondary battery according to another exemplary embodiment of the present invention;

FIG. 5B is a perspective view schematically illustrating the negative plate of FIG. 5B;

FIG. 6 schematically illustrates a roll coating device according to an exemplary embodiment of the present invention;

FIG. 7 schematically illustrates a roll coating device according to another exemplary embodiment of the present invention; and

FIG. 8 schematically illustrates a roll coating device according to still another exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings.

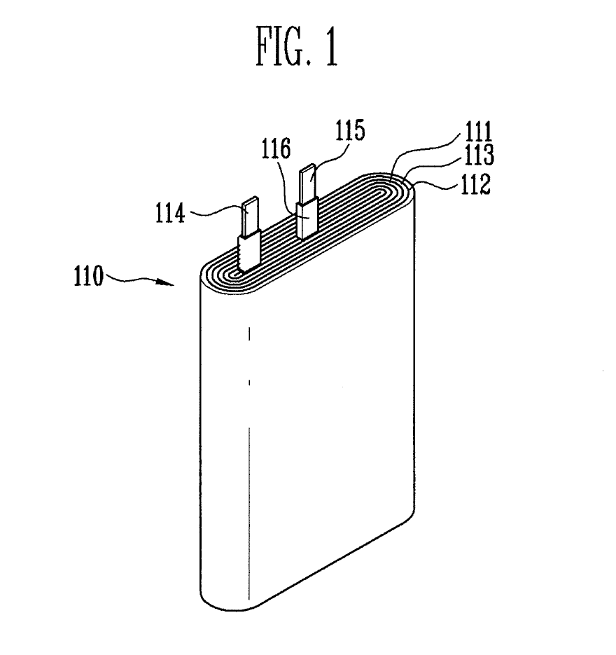

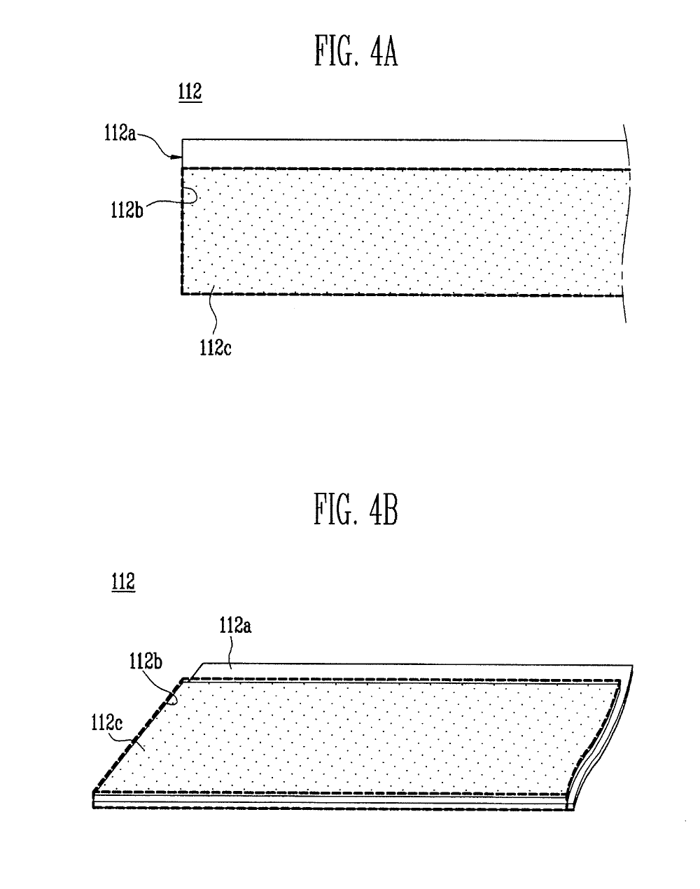

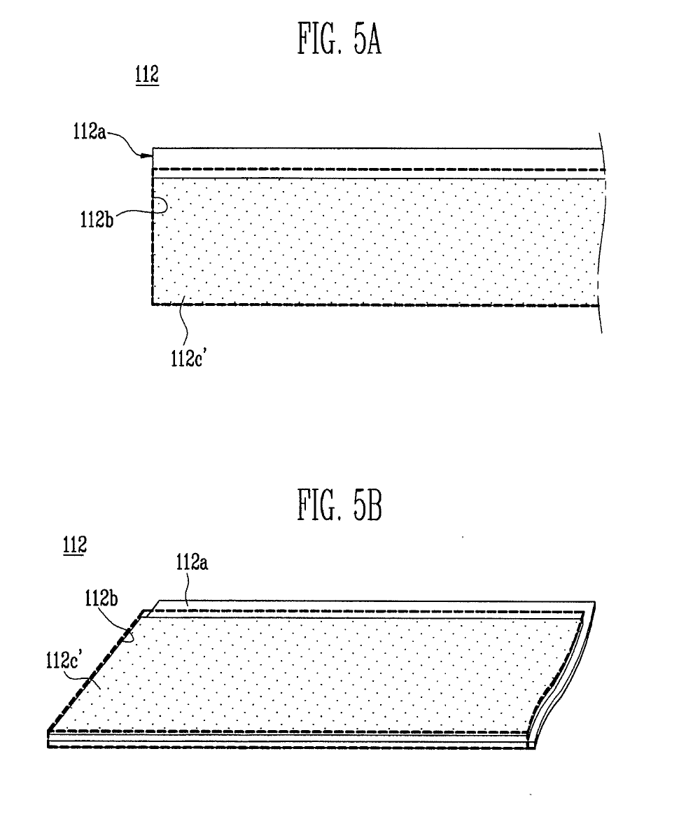

FIGS. 1 to 5B schematically illustrate an electrode assembly, a positive plate or a negative plate according to exemplary embodiments of the present invention.

In FIG. 1, the electrode assembly 110 for a secondary battery according to an exemplary embodiment of the present invention includes a positive plate 111, a negative plate 112, and a separator 113 located between the two plates 111 and 112. Generally, the positive plate 111 may be a thin plate of aluminum (Al), and the negative plate 112 may be a thin plate of copper (Cu). However, the positive plate 111 and the negative plate 112 are not limited to the above metals. The electrode assembly 110 may further include a positive tab 114 and a negative tab 115, each of which have one end portion protruding from the positive and negative plates 111, 112. In addition, an insulating tape 116 is wound around a portion of the positive tab 114 and the negative tab 115 protruding on the upper part of the electrode assembly 110 to prevent a short circuit between the plates 111 and 112. Generally, the electrode assembly 110 is manufactured by inserting the separator 113 between the positive plate 111 and the negative plate 112 to insulate them from each other and winding the plates and the separator into a jelly roll in order to increase an electric capacity.

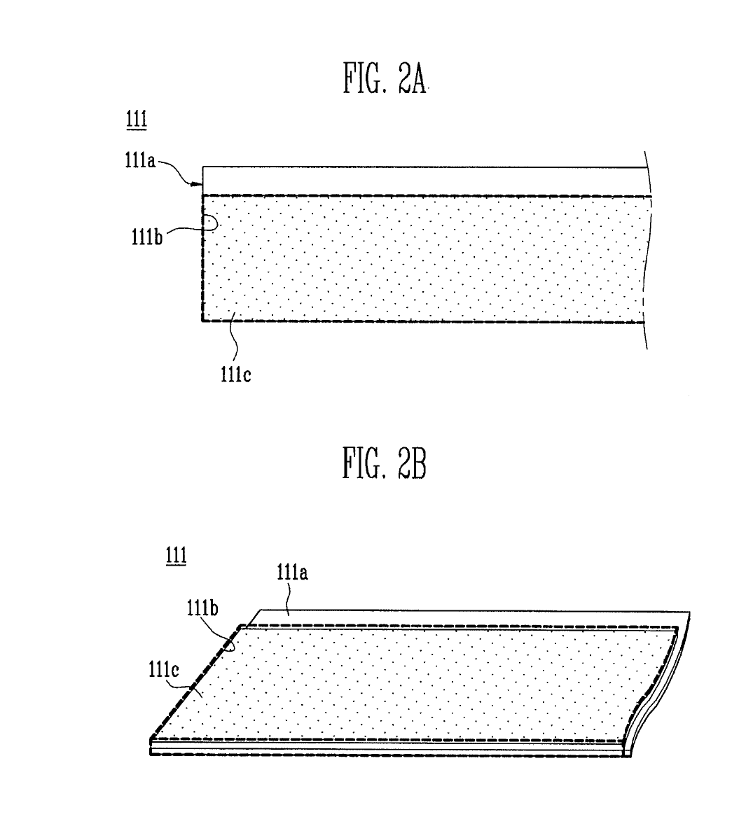

Referring to FIGS. 2A , 2B, 4A, and 4B, a positive active material and a negative active material are applied to one surface of the positive plate 111 and one surface of the negative plate 112, respectively, to form an active part 111b and 112b.

The positive active material may include manganese oxides having a high stability, and the negative active material may include carbon-based compounds. However, the active materials are not limited to the above materials. A non-applied part 111a and 112a is formed on a portion of the surface to which the positive active material or the negative active material is not applied. In the present embodiment, a part which extends or is bent from the active part 111b and 112b is defined as a side part. The side part practically refers to a cut side when the positive plate 111 and the negative plate 112 are cut in a lengthwise direction.

According to the present embodiment, the side part is coated with an inorganic coating layer 111c and 112c. In detail, the inorganic coating layer 111c and 112c is formed to cover the side part in the lengthwise direction of the positive plate 111 and the negative plate 112. Further, the inorganic coating layer 111c and 112c also covers the active part 111b and 112b. Here, the inorganic coating layer 111c and 112c may have a thickness of between about 1 μm and about 15 μm.

In one embodiment, the inorganic coating layer 111c and 112c is formed by applying slurry containing inorganic ceramic paste and drying the slurry, wherein the inorganic ceramic paste may include ceramic powder of at least one selected from alumina, zirconia, and an alumina-zirconia mixture. The ceramic powder may be included at about 7% or less of the total weight of the inorganic ceramic paste, and the inorganic ceramic paste may have a viscosity of between about 1 cps and about 500 cps.

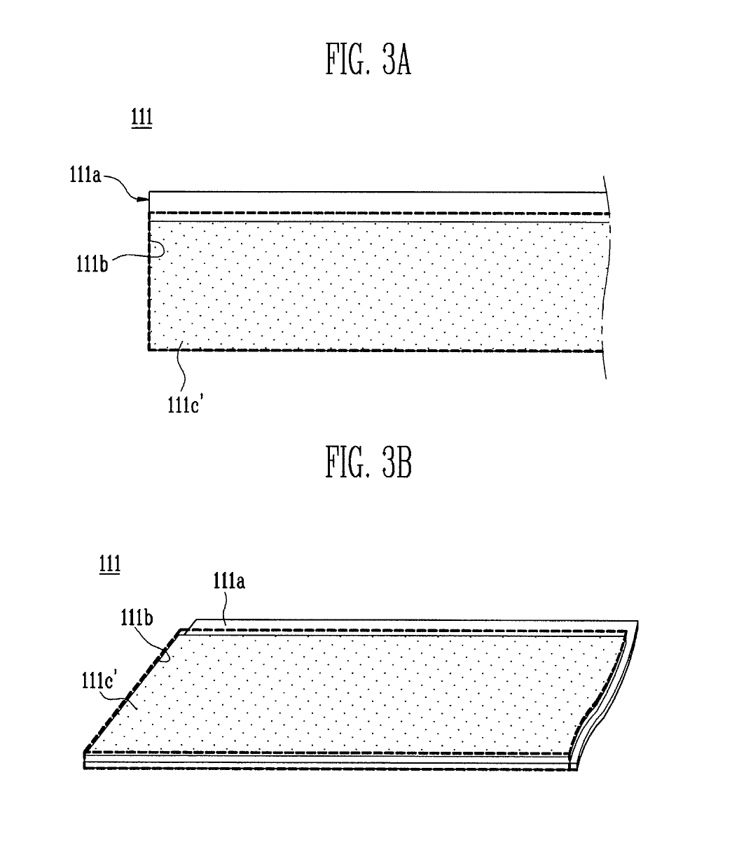

Referring to FIGS. 3A, 3B, 5A, and 5B, another exemplary embodiment of the present invention is described. An active part 111b and 112b is formed by applying a positive active material and a negative active material to one surface of a positive plate 111 and one surface of a negative plate 112, respectively. Further, a non-applied part 111a and 112a is formed on a portion of the one surface which the positive active material or the negative active material is not applied to.

In the present embodiment, a side part is coated with an inorganic coating layer 111c′ and 112c′. In detail, the inorganic coating layer 111c′ and 112c′ is formed to cover the side part in the lengthwise direction of the positive plate 111 and the negative plate 112. Further, the inorganic coating layer 111c′ and 112c′ also covers the active part 111b and 112b. However, unlike the above embodiment, the inorganic coating layer 111c′ and 112c′ is formed not only to cover an upper side of the active part 111b and 112b but to extend to cover a portion of the non-applied part 111a and 112a. Here, the inorganic coating layer 111c′ and 112c′ may have a thickness of between about 1 μm and about 15 μm. When the inorganic coating layer 111c′ and 112c′ has a thickness of 1 μm or less, thermal stability may not be securely achieved. When the inorganic coating layer 111c′ and 112c′ has a thickness of 15 μm or more, thermal stability is excellent, but an ion transfer speed is decreased during charging and discharging. Further, a volume of the inorganic coating layer in a secondary battery 100 increases, and thus a capacity per unit volume may decrease as compared with a secondary battery 100 having the same size.

In one embodiment, the inorganic coating layer 111c′ and 112c′ is also formed by applying slurry containing inorganic ceramic paste and drying the slurry, wherein the inorganic ceramic paste may include ceramic powder of at least one selected from alumina, zirconia, and an alumina-zirconia mixture. The ceramic powder may be included at about 7% or less of the total weight of the inorganic ceramic paste, and the inorganic ceramic paste may have a viscosity of between about 1 cps and about 500 cps. That is, when the ceramic powder is included at 7% or less of the total weight of the inorganic ceramic paste, and a viscosity of the inorganic ceramic paste is maintained within a range of 1 cps to 500 cps, a target thickness of the inorganic coating layer 111c′ and 112c′ may be maintained within a range of 1 μm to 15 μm.

As described above, the inorganic coating layer 111c, 112c, 111c′, and 112c′ is formed on the active part 111b and 112b of the positive plate 111 and the negative plate 112, the side part, and the portion of the non-applied part 111a and 112a, thereby preventing occurrence of a short circuit or explosion of a battery caused by burrs which are inevitably formed on cut surfaces of the positive plate 111 and the negative plate 112. In addition, the separator 113 formed of a porous material which is vulnerable to heat is supplemented to reinforce thermal stability of the battery.

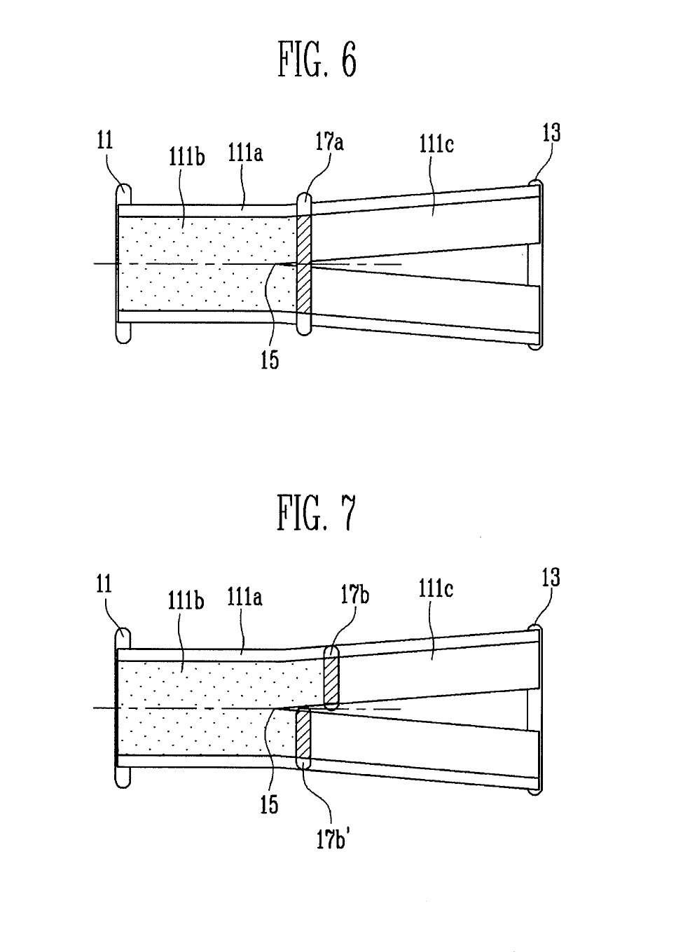

Hereinafter, a process of forming an inorganic coating layer on a positive plate according to an exemplary embodiment of the present invention is described schematically with reference to FIGS. 6 to 8.

First, the positive plate 111 including an active part 111b formed by applying an active material on one surface of the positive plate 111, a non-applied part 111c that is a portion of the surface to which the active material is not applied, and a side part that is a portion of the surface bent from the active part 111b is provided.

As shown in FIG. 6, the positive plate 111 is cut into a desired size using a slitter 15. Then, the inorganic coating layer 111c is formed on the side part bent from the active part 111b. Here, the inorganic coating layer 111c may be formed on the surface of the positive plate 111 to cover the side part in a lengthwise direction of the positive plate 111. Further, the inorganic coating layer 111c is formed to cover the active part 111b. A process of forming the inorganic coating layer 111c may be performed by a roll coating device 17a. The roll coating device 17a may be oriented to cover the positive plate 111 which is not yet cut transversely with respect to a thickness direction of the positive plate 111, and includes inorganic ceramic paste for forming the inorganic coating layer 111c throughout an inside or a lower part. The positive plate 111 is cut into the desired size using the slitter 15, and the inorganic coating layer 111c is formed on the surface of the positive plate 111 using the roll coating device having an un-winder 11 and a re-winder 13. Here, the inorganic coating layer 111c may be formed by applying slurry containing inorganic ceramic paste and drying.

The above cutting process and the process of forming the inorganic coating layer 111c may be performed simultaneously or sequentially.

Also, like in the other exemplary embodiment, the inorganic coating layer 111c may be formed to cover a portion of the non-applied part 111a.

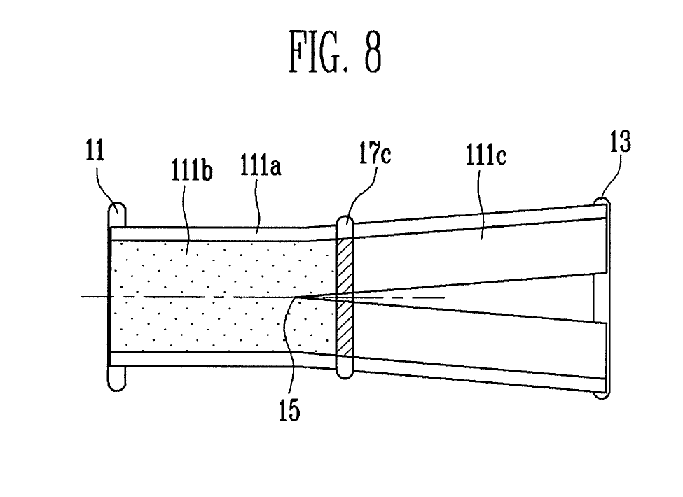

As shown in FIG. 7, a plurality of roll coating devices 17b and 17b′ may be provided to freely form the inorganic coating layer 111 c. As shown in FIG. 8, inorganic ceramic paste for the inorganic coating layer 111c is put in a portion of one roll coating device 17c, and the device is driven to form the inorganic coating layer 111c in a desired position.

The electrode assembly 110 may be accommodated in a case, or a plurality of electrode assemblies 110 are accommodated in a single case to form into a high-capacity product. The case may be sealed by a cap assembly.

According to exemplary embodiments of the present invention, there is provided a secondary battery which relieves occurrence of burrs on a cut surface of the electrode assembly and supplements a low thermal stability of a separator and a method of manufacturing the same. Moreover, the likelihood of an occurrence of a short circuit and/or explosion of a battery is significantly reduce to improve reliability of a product. In addition, occurrence of a defective battery is minimized in a manufacturing process of a battery to reduce manufacturing costs.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrode assembly comprising a positive plate, a negative plate, and a separator located between the positive plate and the negative plate, each of the positive plate and the negative plate comprising an active part formed by applying an active material to at least one surface and a non-applied part from which the active material is omitted,
wherein a side part extending from at least one of the active part of the positive plate and the active part of the negative plate is coated with an inorganic coating layer.

2. The electrode assembly of claim 1, wherein the inorganic coating layer covers the side part in a lengthwise direction of the positive plate or the negative plate.

3. The electrode assembly of claim 2, wherein the inorganic coating layer entirely covers the active part.

4. The electrode assembly of claim 3, wherein the inorganic coating layer covers a portion of the non-applied part.

5. The electrode assembly of claim 1, wherein the inorganic coating layer comprises a dried inorganic ceramic material.

6. The electrode assembly of claim 5, wherein the inorganic ceramic material comprises ceramic powder of at least one selected from alumina, zirconia, and an alumina-zirconia mixture.

7. The electrode assembly of claim 6, wherein the ceramic powder is about 7% or less of a weight of the inorganic ceramic material.

8. The electrode assembly of claim 5, wherein the inorganic ceramic material has a pre-dried viscosity of between about 1 cps to about 500 cps.

9. The electrode assembly of claim 1, wherein the inorganic coating layer has a thickness of between about 1 μm and about 15 μm.

10. A secondary battery comprising:
an electrode assembly comprising a positive plate, a negative plate, and a separator located between the positive plate and the negative plate, each of the positive plate and the negative plate comprising an active part formed by applying an active material to at least one surface and a non-applied part from which the active material is omitted, wherein a side part extending from at least one of the active part of the positive plate and the active part of the negative plate is coated with an inorganic coating layer;
a positive tab and a negative tab respectively connected to the positive plate and the negative plate of the electrode assembly; and
a case housing the electrode assembly.

11. A method of manufacturing a secondary battery including an electrode assembly having a positive plate, a negative plate, and a separator located between the positive plate and the negative plate, the method comprising:
applying an active material to a portion at least one surface of the positive plate and the negative plate to form an active part and a non-applied part to which the active material is omitted;
cutting the positive plate or the negative plate into a desired size; and
applying an inorganic coating layer on a side part extending from at least one of the active part of the positive plate and the active part of the negative part.

12. The method of claim 11, wherein the cutting and the applying the inorganic coating layer are performed simultaneously.

13. The method of claim 11, wherein the cutting and the applying the inorganic coating layer are performed sequentially.

14. The method of claim 11, wherein the inorganic coating layer is applied to cover the side part in a lengthwise direction of the positive plate or the negative plate.

15. The method of claim 14, wherein the inorganic coating layer is applied to cover the entire active part.

16. The method of claim 15, wherein the inorganic coating layer is applied to cover a portion of the non-applied part.

17. The method of claim 11, wherein the cutting is performed by a slitter.

18. The method of claim 11, wherein the inorganic coating layer is applied by a roll coating device.

19. The method of claim 18, wherein the roll coating device comprises a plurality of roll coating devices.

20. The method of claim 18, wherein applying the inorganic coating layer comprises applying a slurry containing an inorganic ceramic paste and drying the slurry.

21. The method of claim 20, wherein the inorganic ceramic paste is provided in a portion of a roll coating device.
